(19) United States
(12) Patent Application Publication
(10) Pub. No.: US 2026/0244169 A1
(43) Pub. Date: Aug. 20, 2026

(54) METHOD, DEVICE, AND APPLICATION FOR CONTROLLING TEMPERATURE BASED ON A PHYSICAL NEURAL NETWORK

(71) Applicant: National Cheng Kung University, Tainan (TW)

(72) Inventors: KUANG-YAO LO, Tainan (TW); Hua-Hsing Liu, Tainan (TW)

(21) Appl. No.: 19/413,125

(22) Filed: Dec. 9, 2025

Related U.S. Application Data
(60) Provisional application No. 63/760,043, filed on Feb. 18, 2025.

(51) Int. Cl. G05B 13/02; G05B 13/04

(52) U.S. Cl. CPC G05B 13/027; G05B 13/048

(57) ABSTRACT

The present invention provides a method, device, and application for controlling temperature based on a physical neural network, wherein a predictive temperature control curve from a temperature prediction model is used for a predictive control model to obtain a target temperature by solving a thermal control parameter of a thermal control device in a prediction state. The thermal control parameter controls a target device to match the predictive temperature control curve, achieving real-time adaptive temperature regulation and overcoming the problems of error prediction in traditional thermal controllers that being unable to resist interferences of external unstable factors. The present invention is widely applicable to various fields, including household appliances, automotive and motorcycle temperature control management systems, heating systems, semiconductor thermal annealing equipment, and industrial furnaces.

### CROSS-REFERENCE TO RELATED APPLICATION

The present application is related to and claims the benefit of U.S. Provisional Application No. 63/760,043, filed Feb. 18, 2025. The aforementioned application is hereby incorporated by reference in its entirety.

### FIELD OF THE INVENTION

The present invention relates to a method, device, and application for controlling temperature, and more particularly, to a method, device, and application for controlling temperature based on a physical neural network.

### BACKGROUND OF THE INVENTION

Existing controllers of traditional thermal control devices often fail to respond immediately when facing nonlinear thermodynamic problems or tremendous environmental changes.

The controllers may even fail to accurately control temperature to match the desired temperature, resulting in prolonging thermal control time and increasing energy consumption.

Besides, control logic of the controllers can be categorized into on-off control, proportional control, proportional-integral-derivative control (PID), and Model Predictive Control (MPC).

On-off control is the most basic method of temperature control, that is, the controllers turn off a device when temperature reaching the setpoint; on the contrary, the controllers turn on the device when temperature not reaching the setpoint.

The method of proportional control adjusts the output according to the temperature differences, but this method may leave residuals.

PID controllers adjust the output according to the current error size of temperature by proportional calculation, eliminate historical accumulated errors by integral calculation, and predict future errors by differential calculation.

In other words, the PID controllers calculate errors to adjust temperature output according to a target temperature and a feedback temperature. However, the PID controllers can only adjust temperature by current and historical errors, but cannot predict future changes.

Also, the PID controllers have poor responds of delay or interference measurement and are difficult dealing with complex dynamic behaviors.

MPC controllers attempt to improve the defects of the PID controllers, but the premise of adopting the MPC controllers is that all conditions must be known. Therefore, it is common for the MPC controllers to fail due to environmental changes.

Furthermore, in order to achieve rapid prediction of physical models, the MPC controllers demand to use the linear equation model, limiting the possibility of predicting nonlinear phenomena and problems such as inaccurate controls, slow responses and energy waste.

In view of the deficiencies mentioned, the present invention provides a method, device, and application for controlling temperature based on a physical neural network.

The present invention combines a temperature prediction model with a predictive control model to achieve precise and real-time adaptive temperature control.

The temperature prediction model embeds a heat transfer law into neural network, and the neural network learns thermodynamic process of a thermal control device, and is trained according to thermodynamic model, thus, being able to adapt to thermal behaviors under various environments.

After that, the predictive control model optimizes prediction and calculates the best control strategy, solving the problem like traditional thermal controllers outputting prediction errors caused by unstable factors.

### SUMMARY OF THE INVENTION

The purpose of the present invention is to provide a method for controlling temperature based on a physical neural network, using a predictive temperature control curve obtained from a temperature prediction model as a prediction of trend of temperature change.

Additionally, the temperature prediction model combines with a predictive control model to construct optimized problems by the predictive temperature control curve.

The predictive control model also calculates the best temperature control strategy in order to control a thermal control parameter of a thermal control device, thereby making a temperature parameter of a target device closer to the predictive temperature control curve.

Therefore, the method achieves operating in continuously adaptive and automatic control, significantly improving prediction accuracy.

Another purpose of the present invention is to provide a device for controlling temperature based on a physical neural network.

The device obtained a temperature parameter of a target device by a temperature sensor, and after performing a computational analysis by a processor, a control unit controls a thermal control parameter of a thermal control device.

Therefore, the device improves the stability of temperature control and has strong adaptability, being applicable to various nonlinear and complicated thermal control fields while effectively reducing unnecessary energy loss.

The other purpose of the present invention is to provide a smart cooking machine applicating a device for controlling temperature based on a physical neural network.

The smart cooking machine is able to recognized food and materials of a target device automatically, and can improve cooking efficiency by optimizing a thermal control parameter automatically according to different cooking environments, food characteristics and material properties through using the device for controlling temperature based on a physical neural network.

Therefore, the smart cooking machine solves problems of traditional PID controllers, such as easily generating temperature vibration, and also solves problems of traditional MPC controllers.

For instance, the MPC controllers must build experience models of various kinds of food, but cannot perform automatic recognition, and is susceptible to external variables, leading to decrease in temperature control accuracy.

To accomplish the purpose mentioned above, one embodiment of the present invention discloses a method for controlling temperature based on a physical neural network, comprising steps of:
using a temperature sensor to obtain a first temperature parameter of a target device;
using a temperature prediction model to perform a first computational analysis based on the first temperature parameter so as to generate a predictive temperature control curve;
using a predictive control model to perform a second computational analysis based on the predictive temperature control curve to control a thermal control parameter of a thermal control device;
using the temperature sensor to obtain a second temperature parameter of the target device; and
using the predictive control model to perform another second computational analysis based on the second temperature parameter to adjust the thermal control parameter, thereby making temperature trends of the target device match the predictive temperature control curve.

In better embodiments, the predictive control model performs the second computational analysis according to an optimized objective function so as to adjust the thermal control parameter.

In better embodiments, the optimized objective function comprises: a target temperature, a temperature departure, an energy consumption, a rate of temperature changed, an output power, a time control, a mode of thermal control, a thermal exchange parameter or a combination of two or more thereof.

In better embodiments, a building method of the temperature prediction model comprises steps of:
embedding a heat transfer law into a neural network by a processor;
obtaining a default thermodynamic information of a default target device; and
training the neural network based on the default thermodynamic information and a thermodynamic model in order to build the temperature prediction model.

In better embodiments, the default thermodynamic information comprises: a temperature variation curve, a thermal delay, a thermal inertia, a thermal stability, a thermal response time, dynamics of thermal transfer, a thermal resistance, a thermal vibration, a thermal source or a combination of two or more thereof.

In better embodiments, wherein in the step of the first computational analysis, the temperature prediction model performs an abduction reasoning process based on the first temperature parameter to obtain a target parameter, and the temperature prediction model then performs a third computational analysis based on the target parameter and generates the predictive temperature control curve.

In better embodiments, the target parameter comprises a material parameter of the target device and a thermodynamic information corresponding to the material parameter.

In better embodiments, the thermodynamic information comprises: a temperature variation curve, a thermal delay, a thermal inertia, a thermal stability, a thermal response time, dynamics of thermal transfer, a thermal resistance, a thermal vibration, a thermal source or a combination of two or more thereof.

To accomplish another purpose mentioned above, one embodiment of the present invention discloses a device for controlling temperature based on a physical neural network, comprising:
a temperature sensor, disposed between a thermal control device and a target device to obtain a temperature parameter of the target device;
a processor comprising:
   a temperature prediction model receiving the temperature parameter and performing a first computational analysis based on the temperature parameter to generate a predictive temperature control curve; and
   a predictive control model receiving the predictive temperature control curve and performing a second computational analysis based on the predictive temperature control curve to generate a control command; and
a control unit receiving the control command and adjusting a thermal control parameter of the thermal control device based on the control command, thereby making the temperature parameter of the target device match the predictive temperature control curve.

In better embodiments, thermal control types of the thermal control device comprise: thermoelectric, phase change cooling, active/passive cooling, thermistor, electromagnetic, electromagnetic wave, thermochemical or thermal cycling system.

In better embodiments, the processor embeds a heat transfer law into a neural network, and the neural network is trained based on a default thermodynamic information and a thermodynamic model of a predicted target device to build the temperature prediction model.

In better embodiments, the default thermodynamic information comprises: a temperature variation curve, a thermal delay, a thermal inertia, a thermal stability, a thermal response time, dynamics of thermal transfer, a thermal resistance, a thermal vibration, a thermal source or a combination of two or more thereof.

In better embodiments, the predictive control model comprises a Model Predictive Control.

To accomplish the other purpose mentioned above, one embodiment of the present invention discloses a smart cooking machine with a device for controlling temperature based on a physical neural network, comprising:
a cooking machine comprising:
   a target device optionally comprising a thermal conductive structure and a food, wherein the food is placed on one side of the thermal conductive structure; and
   a thermal control device placed on the other side of the thermal conductive structure, wherein the thermal control device controls the thermal conductive structure to transfer heat to the food according to a thermal control parameter so as to complete cooking; and
a device for controlling temperature based on a physical neural network, wherein the device is connected to the cooking machine and performs an analysis based on a temperature parameter of the target device to predict a predictive temperature control curve of the target device for controlling the thermal control parameter, wherein the device comprises:
   a temperature sensor, disposed between the target device and the thermal control device to obtain the temperature parameter of the target device;
   a processor comprising: a temperature prediction model and a predictive control model, wherein the temperature prediction model receives the temperature parameter and performs a first computational analysis based on the temperature parameter to generate the predictive temperature control curve, and the predictive control model receives the predictive temperature control curve and performs a second computational analysis based on the predictive temperature control curve to generate a control command; and
a control unit receiving the control command and adjusting the thermal control parameter of the thermal control device based on the control command, thereby making the temperature parameter of the target device match the predictive temperature control curve.

The present invention has beneficial effects of combining physical neural network technology with optimized predictive control, and is able to control temperature precisely and automatically.

Additionally, the present invention has faster response speed and smaller temperature overshoot, and improves energy utilization efficiency.

When confronting nonlinear thermal dynamics, unknown working conditions and environments, the present invention still maintain high prediction accuracy with excellent adaptive capabilities.

Therefore, the present invention can be applied to various nonlinear and complicated thermal control fields, such as household appliances, industrial applications or semiconductor manufacturing industry.

### BRIEF DESCRIPTION OF THE DRAWINGS

FIG. 1A is a flowchart illustrating an embodiment of the present invention;

FIG. 1B is a flowchart illustrating the building method of the temperature prediction model of an embodiment.

FIG. 2 is a block diagram illustrating the device of an embodiment.

FIG. 3 is a comparison chart illustrating result of temperature control of an embodiment.

FIG. 4 is a block diagram illustrating the device of an embodiment.

FIG. 5 is a diagram illustrating the operating result of an embodiment.

### DETAILED DESCRIPTION OF THE INVENTION

To let the above and/or other objects, effects, or features of the present invention more apparent and understandable, preferred embodiments are described in detail below.

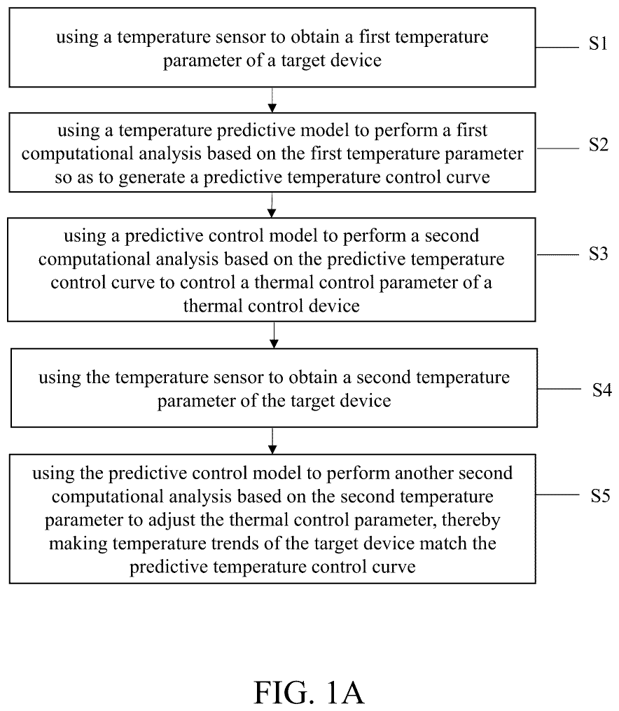

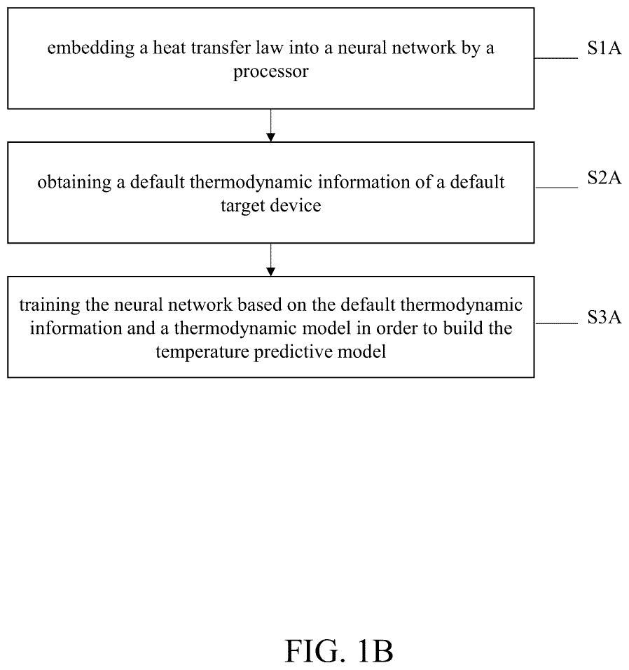

Referring to FIG. 1A, an embodiment of the present invention, a method for controlling temperature based on a physical neural network, comprising steps of:
S1: using a temperature sensor to obtain a first temperature parameter of a target device;
S2: using a temperature prediction model to perform a first computational analysis based on the first temperature parameter so as to generate a predictive temperature control curve;
S3: using a predictive control model to perform a second computational analysis based on the predictive temperature control curve to control a thermal control parameter of a thermal control device;
S4: using the temperature sensor to obtain a second temperature parameter of the target device; and
S5: using the predictive control model to perform another second computational analysis based on the second temperature parameter to adjust the thermal control parameter, thereby making temperature trends of the target device match the predictive temperature control curve.

As described in step S1, using the temperature sensor 1 to obtain the first temperature parameter of the target device T, wherein the target device T is a heated object, specifically the target device T changed while the application field is different.

For instance, when applied in cooking areas, the target device T can be any type of cookware, food or thermal conductivity structure thereof; when applied in industrial areas, the target device T can be a heated workpiece or a thermal conductivity structure thereof.

As described in step S2, the temperature prediction model 21 performs a first computational analysis based on the first temperature parameter so as to generate the predictive temperature control curve.

Specifically, the temperature prediction model 21 performs an abductive reasoning process based on the first temperature parameter to obtain a corresponding target parameter, generating the predictive temperature control curve by performing a third computational analysis based on the target parameter.

In an embodiment, the target parameter comprises a material parameter of the target device T and a thermodynamic information corresponding to the material parameter.

The thermodynamic information comprises: a temperature variation curve, a thermal delay, a thermal inertia, a thermal stability, a thermal response time, dynamics of thermal transfer, a thermal resistance, a thermal vibration, a thermal source or a combination of two or more thereof.

In an embodiment, the thermal delay is a parameter regarding thermal hysteresis phenomena; that is, when temperature changes, reaction of the target device T lags behind actual temperature changes.

The thermal inertia is a parameter regarding thermal resistivity of the target device T, and the thermal stability is a parameter regarding resistance of temperature changes after heated.

The thermal response time is a parameter regarding time required for the target device T in reaction to environmental temperature changes; the thermal resistance is a reciprocal of coefficient of thermal conductivity; the thermal vibration is a parameter regarding periodic oscillation behavior generated by heat source oscillation.

The thermal source is a parameter generally categorized into two types: one is spontaneous heat source, meaning transforming controllable energy, such as internal chemical energy or mechanical energy, into uncontrollable thermal energy; the other is thermal dissipation parameter, meaning non-thermal energy, such as chemical energy or electric energy, transformed from thermal radiation or thermal energy, or energy dissipation not included due to the scope narrowness of system, but not limited to this.

Specifically, when applied in cooking areas, the target device T can be various cookware, including food simultaneously, and in this case, the target parameter comprising a material parameter of the cookware and its corresponding thermodynamic information, and a material parameter of the food and its corresponding thermodynamic information.

Take cooking area for example, the abduction reasoning here can be performed according to coefficient of thermal conductivity, and when the target device T comprises the cookware and the food, equations are derived as below:

$${T}_{M / env} = \frac{{T}_{M / env} + \frac{hdx}{{k}_{s}} {T}_{env}}{1 + \frac{hdx}{{k}_{s}}} \qquad Equation ( 1 )$$

$$\frac{\partial {T}_{M}}{\partial t} - \frac{{h}_{q , M}}{{ρ}_{M} {C}_{v , M}} {∇}^{2} T = \frac{Power ( J / s ) ( {P}_{rad} + {P}_{chem} )}{{ρ}_{M} {C}_{v , m} {V}_{M}} \qquad Equation ( 2 )$$

$${T}_{i}^{n + 1} = {T}_{i}^{n} + \frac{dt}{{ρ}_{GM} {C}_{v , GM} dx} ( \frac{2 {k}_{i + 1} {k}_{i}}{{k}_{i + 1} + {k}_{i}} \frac{{T}_{i + 1} - {T}_{i}}{dx} - \frac{2 {k}_{i} {k}_{i - 1}}{{k}_{i} + {k}_{i - 1}} \frac{{T}_{i} - {T}_{i - 1}}{dx} ) \qquad Equation ( 3 )$$

$$\frac{\partial {T}_{G}}{\partial t} - \frac{{k}_{q , G}}{{ρ}_{G} {C}_{ν , G}} {∇}^{2} {T}_{G} = 0 \qquad Equation ( 4 )$$

$${T}_{j}^{n + 1} = {T}_{j}^{n} + \frac{dt}{{ρ}_{HG} {C}_{v , HG} dx} ( \frac{2 {k}_{j + 1} {k}_{j}}{{k}_{j + 1} + {k}_{j}} \frac{{T}_{j + i} - {T}_{j}}{dx} - \frac{2 {k}_{j} {k}_{j - 1}}{{k}_{j} + {k}_{j - 1}} \frac{{T}_{j} - {T}_{j - 1}}{dx} ) \qquad Equation ( 5 )$$

$$\frac{\partial {T}_{H}}{\partial t} - \frac{{k}_{q , H}}{{ρ}_{H} {C}_{ν , H}} {∇}^{2} T = \frac{Power ( J / s ) ( {P}_{ele} + {P}_{rad} )}{{ρ}_{H} {C}_{ν , H} {V}_{H}} \qquad Equation ( 6 )$$

$${T}_{H / env} = \frac{{T}_{H / env} + \frac{hdx}{{k}_{s}} {T}_{env}}{1 + \frac{hdx}{{k}_{s}}} \qquad Equation ( 7 )$$

In equations (1) to (7) given above, wherein TH represented cookware temperature, T_{M} represented food temperature, T_{A} represented air temperature, Pₑₗₑ represented electro thermal power, P_{rad} represented radiant energy, P_{chem} represented chemical energy, hi represented effective convection coefficient, ki represented effective thermal conductivity coefficient, Cᵢ represented effective heat capacity ratio, and ρᵢ represented effective mass density.

In an embodiment, P_{chem}=P_{water}+Pₚᵣₒₜₑᵢₙ+Pₒᵢₗ+P_{Maillard}, meaning that the chemical energy is a combination of chemical energy generated from water, protein, oil and Maillard reaction, but not limited to the above.

In an embodiment, P_{rad}≈AεσT⁴ (J/s), meaning that the radiant energy follows Stefan-Boltzmann law, but not limited to the above.

The effective convection coefficient, the effective thermal conductivity coefficient, the effective heat capacity ratio, and the effective mass density are then derived according from Equation (1) to (7) above.

Therefore, the material parameter of the cookware and its corresponding thermodynamic information, and the material parameter of the food and its corresponding thermodynamic information can then be predicted, generating the corresponding predictive temperature control curve.

As described in step S3, the predictive control model 22 performs a computational analysis based on the predictive temperature control curve obtained in step S2 to control the thermal control parameter of the thermal control device H.

In an embodiment, the predictive control model 22 performs a computational analysis according to an optimized objective function to adjust the thermal control parameter.

In an embodiment, the optimized objective function comprises: a target temperature, a temperature departure, an energy consumption, a rate of temperature changed, an output power, a time control, a mode of thermal control, a thermal exchange parameter or a combination of two or more thereof, but not limited to the above.

Specifically, using the temperature prediction model 21 as a physical model of the predictive control model 22 to calculate and analyze, wherein there is an equation of J as below:

$$J = {\sum }_{i = 1}^{N} {{w}_{{x}_{i}} ( {r}_{i} - {x}_{i} )}^{2} + {\sum }_{i = 1}^{N} {{w}_{{u}_{i}} ( Δ {u}_{i} )}^{2}$$

The equation of J generates differences between prediction temperature xᵢ and value of the predictive temperature control curve rᵢ at several subsequent time points, and adjust the thermal control parameter, such as input power intensity uᵢ, based on the differences.

As described in step S4, using the temperature sensor 1 to obtain a second temperature parameter of the target device T.

As described in step S5, using the predictive control model 22 to perform another second computational analysis based on the second temperature parameter to adjust the thermal control parameter, thereby making temperature trends of the target device T match the predictive temperature control curve.

That is to say, the temperature parameter changed every time is set as an initial condition, in order to obtain the differences between the prediction temperature xᵢ and the value of the predictive temperature control curve rᵢ.

By circulatory control as described above, temperature trends of the target device T are able to match the predictive temperature control curve.

In an embodiment, the thermal control parameter is a relevant condition of adjusting temperature, and differs according to types of the thermal control device H, wherein the thermal control parameter comprises output power, flow rate of gas, current, and so on.

In an embodiment, referring to FIG. 1B, a flowchart illustrating the building method of the temperature prediction model 21 of an embodiment, wherein the building method comprises steps of:
S1A: embedding a heat transfer law into a neural network by a processor;
S2A: obtaining a default thermodynamic information of a default target device; and
S3A: training the neural network based on the default thermodynamic information and a thermodynamic model in order to build the temperature prediction model 22.

The default thermodynamic information comprises a temperature variation curve, a thermal delay, a thermal inertia, a thermal stability, a thermal response time, dynamics of thermal transfer, a thermal resistance, a thermal vibration, a thermal source or a combination of two or more thereof, but not limited to the above.

In an embodiment, as described in step S1A, a heat transfer law is embedded into a neural network by a processor 2; exemplarily, the heat transfer law comprises a heat conduction equation, a heat convection equation, a heat radiation equation, an energy conservation law or a combination of two or more thereof, but not limited to the above.

As described in step S2A, a default thermodynamic information of a default target device is obtained, wherein the default thermodynamic information also comprises a temperature variation curve, a thermal delay, a thermal inertia, a thermal stability, a thermal response time, dynamics of thermal transfer, a thermal resistance, a thermal vibration, a thermal source or a combination of two or more thereof.

The default thermodynamic information can also be actual experimental data of the default target device.

For instance, in cooking areas, the default thermodynamic information can be the actual stewing and cooking pattern; that is, the temperature variation curve may describe the following scenarios: blanching in a low temperature during a specific time, stewing in a gradually increasing temperature during another specific time, and finally, gradually cooling down during another specific time.

Simultaneously, parameters including the thermal delay, the thermal inertia, the thermal stability, the thermal response time, the dynamics of thermal transfer, the thermal resistance, the thermal vibration or the thermal source may be obtained according to parameters of the default target device, such as a thermal conductivity, a specific heat capacity, a density, a thermogravimetric analysis curve, a shape, or a boundary condition.

As described in step S3A, the neural network is trained based on the default thermodynamic information and a thermodynamic model in order to build the temperature prediction model 22; in other words, physical constraints are added to loss functions of the neural network, and the neural network model is able to fit under the premise of satisfying the known physical laws during training.

In an embodiment, the neural network comprises a Physics informed machine learning, a Physics informed neural network, a Physics-Informed Neural Operator (PINO), a DeepONet, a Physics-Informed Kolmogorov—Arnold Networks (PIKAN), a Physics-Informed Wavelet Neural Operator (PIWNO), or a combination of two or more thereof, but not limited to this.

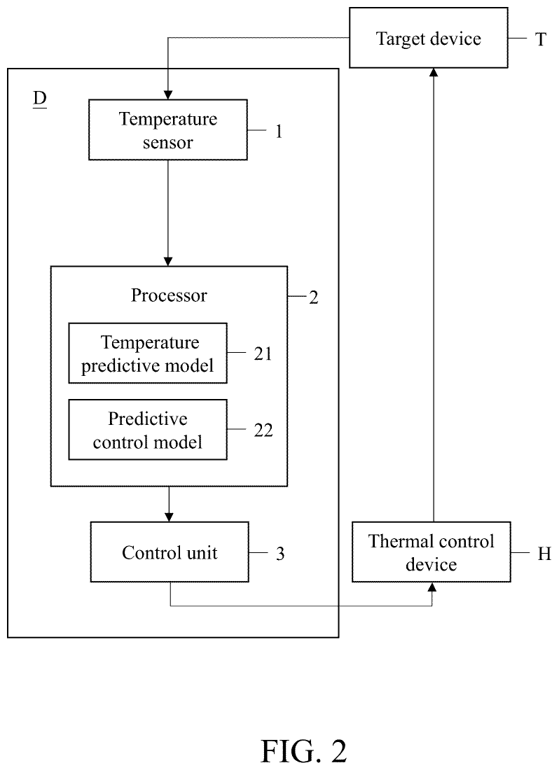

Referring to FIG. 2, a block diagram illustrating the device of an embodiment, wherein a device D for controlling temperature based on a physical neural network of the embodiment comprises a temperature sensor 1, a processor 2, and a control unit 3.

The processor 2 connects to the temperature sensor 1 and the control unit 3 by signal respectively, and description of the device D is explained as below.

In an embodiment, the temperature sensor 1 is disposed between a thermal control device H and a target device T, obtaining a temperature parameter of the target device T, wherein the amount of the temperature sensor 1 is unlimited, and can set based on demand, such as contact area of thermal exchange.

In an embodiment, thermal control types of the thermal control device H comprise: thermoelectric, phase change cooling, active/passive cooling, thermistor, electromagnetic, electromagnetic wave, thermochemical or thermal cycling system, but not limited to the above.

The processor 2 comprises a temperature prediction model 21 and a predictive control model 22, wherein the temperature prediction model 21 receives the temperature parameter and performs a first computational analysis based on the temperature parameter and generates a predictive temperature control curve; the predictive control model 22 receives the predictive temperature control curve and performs a second computational analysis based on the predictive temperature control curve to generate a control command.

The control command comprises a series of control strategies, but not limited to this.

In an embodiment, the building method of the temperature prediction model 21 is described as in step S1A to S3A, that is, the processor 2 embeds the heat transfer law into the neural network, and the neural network is trained based on the default thermodynamic information and the thermodynamic model, building the temperature prediction model 21.

As mentioned above, the default thermodynamic information comprises: a temperature variation curve, a thermal delay, a thermal inertia, a thermal stability, a thermal response time, dynamics of thermal transfer, a thermal resistance, a thermal vibration, a thermal source or a combination of two or more thereof.

In an embodiment, the predictive control model 22 comprises a Model Predictive Control (MPC), but not limited to this.

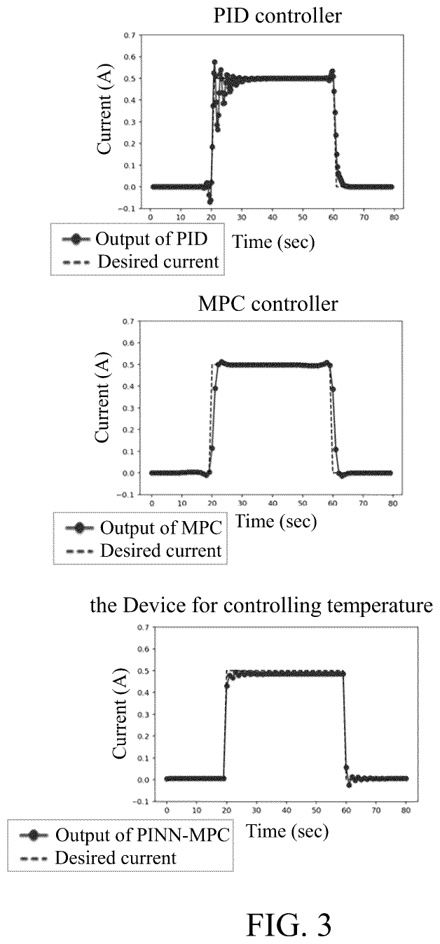

Referring to FIG. 3, a comparison chart illustrating result of temperature control of an embodiment, wherein the control unit 3 receives the control command and adjusts a thermal control parameter of the thermal control device H based on the control command, thereby making the temperature parameter of the target device T match the predictive temperature control curve.

Also referring to FIG. 3, a PID controller, an MPC controller and the device D of the embodiment control current according to a current heating curve respectively, wherein dashed lines represent default predictive temperature control curve, and spots represent output current signals of the PID controller, the MPC controller and the device D after actual operation.

Additionally, as shown in FIG. 3, the output current of the device D is closer to the current heating curve, indicating a significantly greater control precision when compared to traditional PID controller and MPC controller.

In an embodiment, the thermal control parameter varies according to the type of the thermal control device H, the type of thermal control may be thermoelectric type, phase change cooling type, active/passive cooling type, thermistor type, electromagnetic type, electromagnetic wave type, thermochemical type or a thermal cycling system, but not limited to the above.

For instance, principle of the thermoelectric type of thermal control is based on thermoelectric effect; that is, the energy carried by the current at both ends is asymmetric, thereby generating a heat flow, and finally resulting in a cooling effect on one side and a heating effect on the other side; thus, either cooling or heating may be enabled in forms of thermoelectric cooling chips or heating chips, for example.

Principle of the phase change cooling type of thermal control is that when solid change into liquid or liquid change into gas, there is a fixed temperature but occurrence of heat absorption continues.

Specifically, the evaporation temperature of water is 100° C. In fact, liquid water molecules absorb heat energy, causing the distances between water molecules to increase, and the potential energy of water molecules is raised until the water molecules enter free water vapor state.

The active/passive cooling type of thermal control comprises active cooling type and passive cooling type.

For the purpose of lowering the indoor temperature, the active cooling type, such as a cooling compressor, has a process of compressing internal gas to raise temperature, and expanding the gas to an original volume as being under atmospheric pressure by cooling water or refrigerant which absorb heat in a cooling area.

On the other hand, the passive cooling type, such as vertical fins and heat sink, dissipates heat through heat convection.

Principle of the thermistor type of thermal control relies on electric energy transformed into thermal energy when current passes through electric resistance materials.

Principle of the electromagnetic type of thermal control relies on Eddy current, while the Eddy current appears in a magnetic field generated by electric current passing through coils.

The electromagnetic wave type of thermal control, such as infrared heating or microwave heating, uses the characteristic of radiation of electromagnetic wave to transfer heat.

Principle of the thermochemical type of thermal control relies on transforming chemical reaction energy into thermal energy.

The thermal cycling system type of thermal control, such as compression refrigeration system, controls the refrigerant circulation and airflow to achieve temperature regulation.

Therefore, according to different types of the thermal control device H, the thermal control parameter comprises output power, PWM period, alternating frequency, coil current intensity, irradiation power, electromagnetic wave wavelength, reactant quantity, compression ratio, refrigerant flow rate, and gas convection efficiency, but not limited to the above.

The detailed description of an application of a device for controlling temperature based on a physical neural network is explained below.

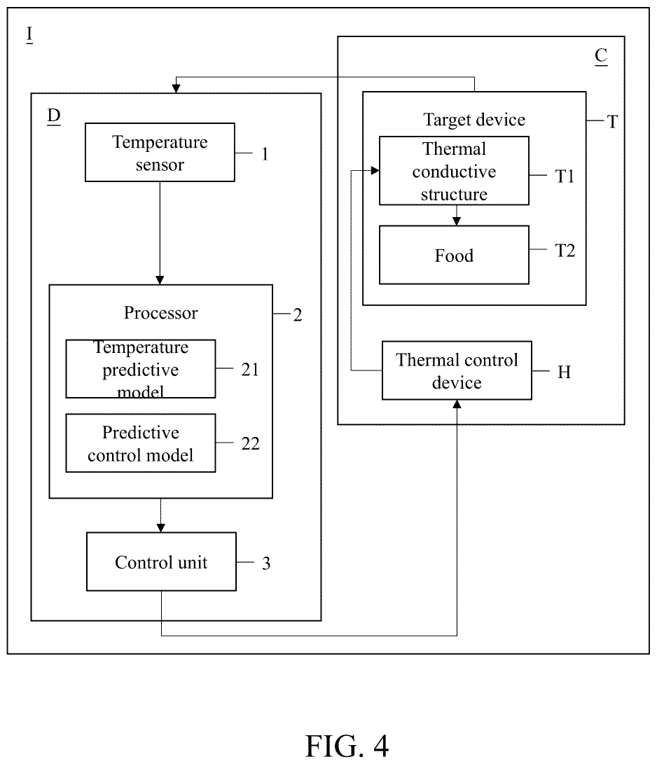

Referring to FIG. 4, a block diagram illustrates the device in one embodiment of the present invention, and a smart cooking machine I with a device for controlling temperature based on a physical neural network comprises a cooking machine C and a device D for controlling temperature based on a physical neural network.

As mentioned above, the cooking machine C is connected to the device D by signal, and detailed descriptions are provided in the following.

The cooking machine C comprises a target device T and a thermal control device H, wherein the target device T comprises a thermal conductive structure T1 and a food T2.

The food T2 is placed on one side of the thermal conductive structure T1, and the thermal control device H is placed on the other side of the thermal conductive structure T1, wherein the thermal control device H assists the thermal conductive structure T1 in transferring heat to the food T2 according to a thermal control parameter to complete cooking, but the way in transferring heat is not limited to the above.

The working mechanism and methods to operate the device D have been illustrated hereinabove, further elaboration is omitted hereinafter.

The device D performs analysis based on a temperature parameter of the target device T and predicts a predictive temperature control curve of the target device T.

In short, the device D performs analysis based on the temperature parameter and determines features of the food T2 and the thermal conductive structure T1.

In light of this, a material parameter of the food T2 with its corresponding thermodynamic information and a material parameter of the thermal conductive structure T1 with its corresponding thermodynamic information are obtained.

The material parameters and the thermodynamic information are subjected to determination of the predictive temperature control curve, and the thermal control parameter is then controlled according to the temperature control curve.

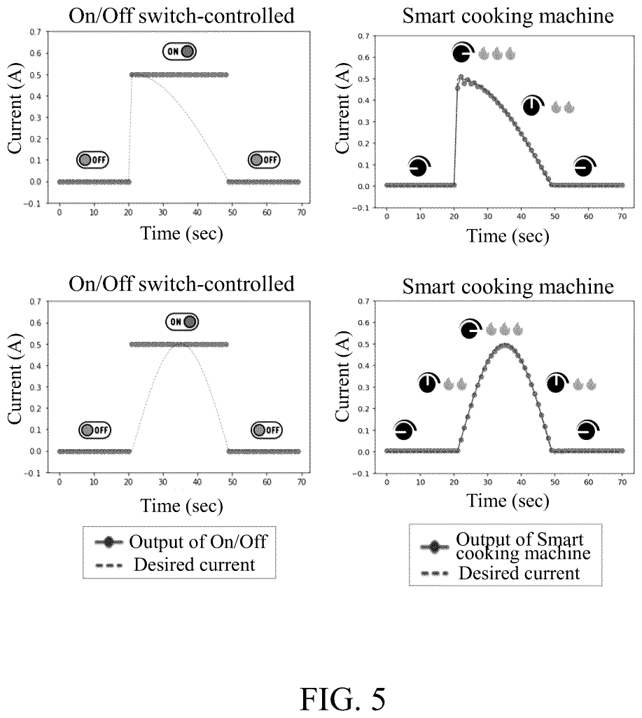

To clearly demonstrate the advantages of the present invention, referring to FIG. 5, a diagram illustrates the operating result of an embodiment, exhibiting a comparison between current controlled curve of the embodiment of the smart cooking machine I and current controlled curve of a On/Off switch-controlled method.

### Embodiment 1

Transforming a step of heating done by an actual chef. “starting by blanching at a low temperature, then gradually increasing the heat to stew, and finally slowly lowering the temperature” into a corresponding current heating curve.

After that, adjusting temperature according to the current heating curve by the smart cooking machine I and the On/Off switch-controlled method respectively.

The smart cooking machine I controls the thermal control parameter precisely and has an 30% economizing of energy compared to the On/Off switch-controlled method, wherein the energy is calculated based on a specific time and its corresponding current amount.

At the same time, referring to FIG. 5 again, dashed lines represent ideal heating curve, and spots represent actual output current signals of the smart cooking machine I.

Consequently, the device D for controlling temperature in the smart cooking machine I can accurately reproduce the desired current output curve, but no comparable result could be observed under the traditional On/Off switch-controlled method.

### Embodiment 2

Under a fixed heating time, the temperature is adjusted according to the current heating curve of the smart cooking machine I and the On/Off switch-controlled method respectively.

Compared to the On/Off switch-controlled method, the smart cooking machine I can save 50% of energy, and the energy is calculated base on a specific time and its corresponding current amount.

From Embodiments 1 and 2, the smart cooking device I saves energy more effectively than the On/Off switch-controlled method, and the smart cooking device I also controls the heating process more precisely, thereby improving thermal efficiency and energy utilization.

The smart cooking machine I can not only monitor and control the thermal control device H to distribute temperature of the target device T uniformly without local overheating or local cold spot, but also optimize the thermal parameter automatically according to different situation, such as humidity, change of airflow, and material characteristics to achieve real-time adaptation to environmental changes, thereby improving efficiency and reducing energy consumption.

### Embodiment 3

Additionally, traditional PID controllers are prone to overheating or underheating because of using fixed parameters to adjust the temperature, causing temperature fluctuations and resulting in problems such that the food is either externally burnt or internally undercooked.

The MPC controllers, on the other hand, requires built-in experience models for various kinds of food, and users need to manually select the food type so that the system of MPC controllers can adjust the heat according to the corresponding characteristics, but the MPC controllers are easily affected by external variables, leading to a decrease in accuracy.

On the contrary, the embodiment of the smart cooking device I overcomes the problems mentioned above by analyzing the thermal characteristics of the food under different environments using a temperature prediction model, and generates the corresponding predictive temperature control curves, thereby making the cuisine closer to the optimal flavor.

The smart cooking device I also match the appropriate heat transfer mechanism accurately using predictive controllers, ensuring that the food reach an ideal cooking level, achieving a more stable and intelligent cooking experience.

In conclusion, the present invention provides a method, device, and application for controlling temperature based on a physical neural network, predicting temperature and generating control strategies by combining a temperature prediction model with a predictive control model.

The present invention is provided with advantages such as high prediction accuracy, high stability, and strong adaptability, achieving the purpose of automatic adjustment, optimization of energy consumption strategies, and effective reduction of unnecessary energy consumption.

However, the description above is only a preferred embodiment of the present invention, but cannot be used for limiting the scope of the present invention, therefore, any simple or equivalent changes or modifications made in accordance with the contents of the claim and the specification are still covered in scope of the present invention.

What is claimed is:

1. A method for controlling temperature based on a physical neural network, comprising steps of:
using a temperature sensor to obtain a first temperature parameter of a target device;
using a temperature prediction model to perform a first computational analysis based on the first temperature parameter so as to generate a predictive temperature control curve;
using a predictive control model to perform a second computational analysis based on the predictive temperature control curve to control a thermal control parameter of a thermal control device;
using the temperature sensor to obtain a second temperature parameter of the target device; and
using the predictive control model to perform another second computational analysis based on the second temperature parameter to adjust the thermal control parameter, thereby making temperature trends of the target device match the predictive temperature control curve.

2. The method of claim 1, wherein the predictive control model performs the second computational analysis according to an optimized objective function so as to adjust the thermal control parameter.

3. The method of claim 2, wherein the optimized objective function comprises: a target temperature, a temperature departure, an energy consumption, a rate of temperature changed, an output power, a time control, a mode of thermal control, a thermal exchange parameter or a combination of two or more thereof.

4. The method of claim 1, wherein a building method of the temperature prediction model comprises steps of
embedding a heat transfer law into a neural network by a processor;
obtaining a default thermodynamic information of a default target device; and
training the neural network based on the default thermodynamic information and a thermodynamic model in order to build the temperature prediction model.

5. The method of claim 4, wherein the heat transfer law comprises: a heat conduction equation, a heat convection equation, a heat radiation equation, an energy conservation law or a combination of two or more thereof.

6. The method of claim 4, wherein the default thermodynamic information comprises: a temperature variation curve, a thermal delay, a thermal inertia, a thermal stability, a thermal response time, dynamics of thermal transfer, a thermal resistance, a thermal vibration, a thermal source or a combination of two or more thereof.

7. The method of claim 1, wherein in the step of the first computational analysis, the temperature prediction model performs an abduction reasoning process based on the first temperature parameter to obtain a target parameter, and the temperature prediction model then performs a third computational analysis based on the target parameter and generates the predictive temperature control curve.

8. The method of claim 7, wherein the target parameter comprises a material parameter of the target device and a thermodynamic information corresponding to the material parameter.

9. The method of claim 8, wherein the thermodynamic information comprises: a temperature variation curve, a thermal delay, a thermal inertia, a thermal stability, a thermal response time, dynamics of thermal transfer, a thermal resistance, a thermal vibration, a thermal source or a combination of two or more thereof.

10. A device for controlling temperature based on a physical neural network, comprising:
a temperature sensor, disposed between a thermal control device and a target device to obtain a temperature parameter of the target device;
a processor comprising:
a temperature prediction model receiving the temperature parameter and performing a first computational analysis based on the temperature parameter to generate a predictive temperature control curve; and
a predictive control model receiving the predictive temperature control curve and performing a second computational analysis based on the predictive temperature control curve to generate a control command; and
a control unit receiving the control command and adjusting a thermal control parameter of the thermal control device based on the control command, thereby making the temperature parameter of the target device match the predictive temperature control curve.

11. The device of claim 10, wherein thermal control types of the thermal control device comprise: thermoelectric, phase change cooling, active/passive cooling, thermistor, electromagnetic, electromagnetic wave, thermochemical or thermal cycling system.

12. The device of claim 10, wherein the processor embeds a heat transfer law into a neural network, and the neural network is trained based on a default thermodynamic information and a thermodynamic model of a predicted target device to build the temperature prediction model.

13. The device of claim 12, wherein the default thermodynamic information comprises: a temperature variation curve, a thermal delay, a thermal inertia, a thermal stability, a thermal response time, dynamics of thermal transfer, a thermal resistance, a thermal vibration, a thermal source or a combination of two or more thereof.

14. The device of claim 10, wherein the predictive control model comprises a Model Predictive Control.

15. A smart cooking machine with a device for controlling temperature based on a physical neural network, comprising:
a cooking machine comprising:
a target device optionally comprising a thermal conductive structure and a food, wherein the food is placed on one side of the thermal conductive structure; and
a thermal control device placed on the other side of the thermal conductive structure, wherein the thermal control device controls the thermal conductive structure to transfer heat to the food according to a thermal control parameter so as to complete cooking; and
a device for controlling temperature based on a physical neural network, wherein the device is connected to the cooking machine and performs an analysis based on a temperature parameter of the target device to predict a predictive temperature control curve of the target device for controlling the thermal control parameter, wherein the device comprises:
a temperature sensor, disposed between the target device and the thermal control device to obtain the temperature parameter of the target device;
a processor comprising: a temperature prediction model and a predictive control model, wherein the temperature prediction model receives the temperature parameter and performs a first computational analysis based on the temperature parameter to generate the predictive temperature control curve, and the predictive control model receives the predictive temperature control curve and performs a second computational analysis based on the predictive temperature control curve to generate a control command; and
a control unit receiving the control command and adjusting the thermal control parameter of the thermal control device based on the control command, thereby making the temperature parameter of the target device match the predictive temperature control curve.

16. The smart cooking machine of claim 15, wherein the predictive control model performs the second computational analysis according to an optimized objective function so as to adjust the thermal control parameter.

17. The smart cooking machine of claim 16, wherein the optimized objective function comprises: a target temperature, a temperature departure, an energy consumption, a rate of temperature changed, an output power, a time control, a mode of thermal control, a thermal exchange parameter or a combination of two or more thereof.

18. The smart cooking machine of claim 15, wherein the processor embeds a heat transfer law into a neural network, and the neural network is trained based on a default thermodynamic information and a thermodynamic model of a predicted target device to build the temperature prediction model.

19. The smart cooking machine of claim 18, wherein the default thermodynamic information comprises: a temperature variation curve, a thermal delay, a thermal inertia, a thermal stability, a thermal response time, dynamics of thermal transfer, a thermal resistance, a thermal vibration, a thermal source or a combination of two or more thereof.

20. The smart cooking machine of claim 15, wherein the predictive control model comprises a Model Predictive Control.
